(19) United States
(12) Patent Application Publication
(10) Pub. No.: US 2026/0237283 A1
(43) Pub. Date: Aug. 13, 2026

(54) PERSONAL CARE APPLIANCE

(71) Applicant: KONINKLIJKE PHILIPS N.V., EINDHOVEN (NL)

(72) Inventors: GEERT-JAN DARWINKEL, WINSUM (NL); GIJSBERT MARIUS HEEREMA, GRONINGEN (NL)

(21) Appl. No.: 19/470,908

(22) PCT Filed: Mar. 22, 2024
(86) PCT No.: PCT/EP2024/057718

§ 371 Date: Sep. 30, 2025

(30) Foreign Application Priority Data
Mar. 30, 2023 (EP) 23165366.8

(51) Int. Cl. G08B 21/18; A46B 13/02; B26B 21/40

(52) U.S. Cl. CPC G08B 21/182; A46B 13/02; B26B 21/4056

(57) ABSTRACT

There is described a personal care appliance (100). The personal care appliance (100) comprises a handle (110) and a head (120) at an end of the handle (100). The head (120) has a connection portion (121) connectable to a replaceable device (200). The personal care appliance (100) also comprises a sensor (40) configured for sensing acceleration and rotational velocity and a controller (42) configured to: monitor the sensed acceleration and rotational velocity over time; determine that the personal care appliance (100) has experienced an impact rendering the replaceable device (200) unsuitable for further use based on the monitored acceleration and rotational velocity; and transmit a signal indicating that the replaceable device (200) should be replaced in response to the determination that the personal care appliance (100) has experienced an impact rendering the replaceable device (200) unsuitable for further use.

### FIELD OF THE INVENTION

The present disclosure relates to a personal care appliance and a computer-implemented method of determining whether a replaceable device of a personal care appliance is suitable for further use after an impact.

### BACKGROUND OF THE INVENTION

Personal care appliances, such as toothbrushes and shavers, are frequently dropped during use, which may result in damage. For example, if a shaver is dropped teeth or blades of the shaver may become loose or damaged, resulting in less effective cutting of hair and/or local skin irritation. Moreover, there is typically a trade-off between the compactness of personal care appliances and vulnerability to damage when dropped, meaning that the problem of personal care appliances being damaged when dropped cannot be solved simply by changing the materials from which the personal care appliances are made.

Hence, there is a desire to avoid users using personal care appliances that have likely been damaged by being dropped while maintaining personal care appliances that are compact.

EP4112251A1 relates to a personal care device, in particular a hair removal device such as an electric shaver, wherein a hazard determination device is provided for determining hazards for the personal care device.

U.S. Pat. No. 9,689,887B1 discloses a portable electronic device that may monitor onboard sensor information to detect and characterize a fall event.

### SUMMARY OF THE INVENTION

According to an aspect of the present disclosure, there is provided a personal care apparatus according to claim 1. Embodiments including optional features of the personal care apparatus are provided in dependent claims 2 to 11.

According to an aspect of the present disclosure, there is provided a computer-implemented method according to claim 12.

According to an aspect of the present disclosure, there is provided a transitory, or non-transitory, computer-readable medium according to claim 13.

### BRIEF DESCRIPTION OF THE DRAWINGS

For a better understanding of the invention, and to show how embodiments of the same may be brought into effect, reference will be made, by way of example only, to the accompanying Figures, in which:

FIGS. 1A, 1B and 1C show respective front, side, and perspective views of a personal care appliance in the form of a toothbrush where a replaceable device is disconnected;

FIGS. 2A, 2B and 2C show respective front, side, and perspective views of a personal care appliance in the form of a toothbrush where a replaceable device is connected;

FIGS. 3A, 3B and 3C show respective front, side, and perspective views of a personal care appliance in the form of a shaver where a replaceable device is disconnected;

FIG. 4 shows a perspective view of a personal care appliance in the form of a shaver where a replaceable device is connected;

FIG. 5 shows a block diagram of components in a handle of a personal care appliance, the components including a sensor and a controller, according to an embodiment;

FIG. 6 shows a side view of a personal care appliance in the form of a toothbrush experiencing an impact with a surface; and

FIG. 7 shows a computer-implemented method of determining whether a replaceable device of a personal care appliance is suitable for further use after an impact, according to one or more embodiments.

### DETAILED DESCRIPTION OF THE EMBODIMENTS

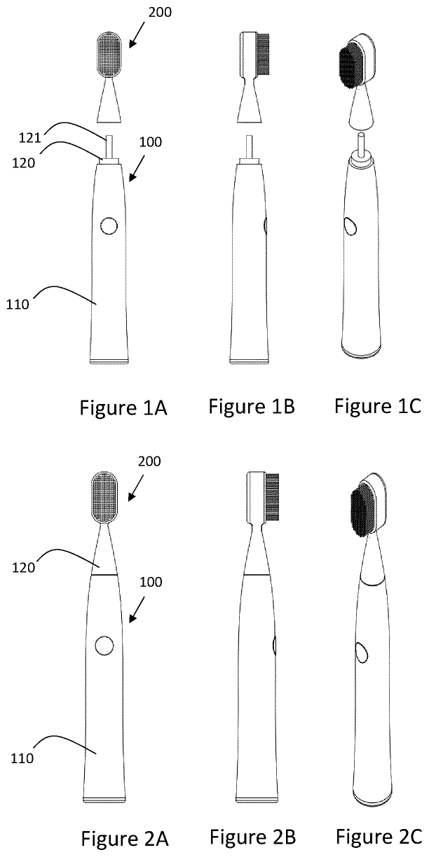

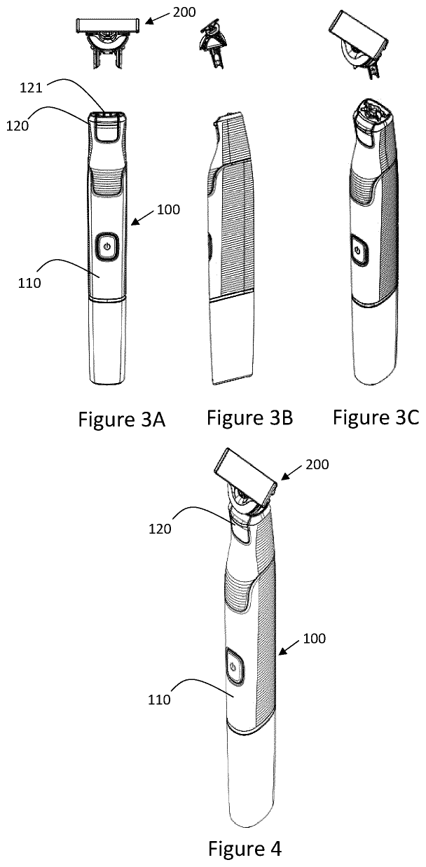

FIGS. 1A, 1B, 1C, 2A, 2B, 2C, 3A, 3B, 3C and 4 each show a personal care appliance 100. In FIGS. 1A, 1B, 1C, 2A, 2B and 2C, the personal care appliance 100 is in the form of a toothbrush. In FIGS. 3A, 3B, 3C and 4, the personal care appliance 100 is in the form of a shaver.

The personal care appliance 100 may be another, for example, handheld apparatus used for personal care or grooming. Personal care appliances 100 include cleaning appliances, skin treatment appliances, hair removal appliances, massage devices, etc. Generally, personal care appliances perform a treatment or an operation to a human or animal body.

Hair cutting appliances and hair grooming appliances are well-known in the art and may comprise, for instance, shaves, trimmers, epilators, hair styling appliances and combinations thereof. Typically, hair grooming appliances comprise an electric motor that is arranged to drive a cutting unit, for instance a blade set, so as to effect a hair cutting and/or grooming operation. More generally, hair cutting appliances may be also referred to as grooming appliances.

The personal care appliance 100 comprises a handle 110 and a head 120 at an end of the handle 110. The head 120 has a connection portion 121 connectable (i.e., attachable and detachable) to a replaceable device 200. The connection portion 121 may be connectable to the replaceable device 200 via a snap-fit or a screw, for instance, allowing easy attachment and detachment of the replaceable device 200. FIGS. 1A, 1B, 1C, 3A, 3B and 3C show the personal care appliance 100 where the replaceable device 200 is disconnected from the head 121. FIGS. 2A, 2B, 2C and 4 show the personal care appliance 100 where the replaceable device 200 is connected to the head 121.

The replaceable device 200 is a functional action unit. For example, in FIGS. 1A, 1B, 1C, 2A, 2B and 2C the replaceable device 200 is a unit comprising bristles for brushing teeth, and in FIGS. 3A, 3B, 3C and 4 the replaceable device 200 is a unit comprising a blade for cutting hair.

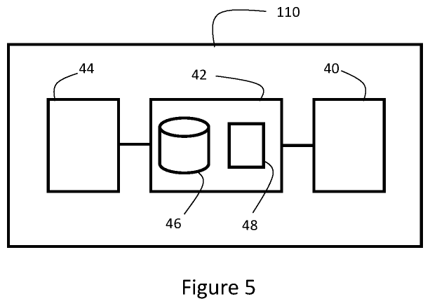

As shown in a block diagram in FIG. 5, the personal care appliance 100 comprises various components, which may be located in the handle 110. Locating components in the handle 110, advantageously, protects them from the environment. Further, locating components in the handle 110, advantageously, engenders a compact personal care appliance 100. The components include a sensor 40 and a controller 42 and, optionally, a power supply 44.

The sensor 40 (e.g., an inertial measurement unit, IMU) is configured for sensing acceleration and rotational velocity. For example, if the personal care appliance 100 is dropped when being used by a user, the sensor 40 senses the acceleration and rotational velocity experienced the personal care appliance 100. Advantageously, sensing the acceleration and rotation velocity experienced by the personal care appliance 100 facilitates determining whether the personal care appliance 100 has experienced an impact resulting in damage to the personal care appliance 100 that renders the personal care appliance 100 unsuitable for further use, as described in more detail below. The sensor 40 may comprise an accelerometer for sensing the acceleration, and the sensor 40 may comprise a gyroscope for sensing the rotational velocity.

The controller 42 is configured to monitor the acceleration and rotational velocity sensed by the sensor 40. Based on the monitored acceleration and rotational velocity, the controller 42 is configured to determine that the personal care appliance 100 has experienced an impact rendering the replaceable device 200 unsuitable for further use. In other words, particular values of acceleration and rotational velocity experienced by the personal care appliance 100 are indicative that the personal care appliance 100 has fallen from such a height and/or at such an angle that damage will likely have been caused to the replaceable device 200 by an impact with a surface on which the personal care appliance 100 has landed, meaning that the performance of the personal care appliance 100 is negatively affected.

The controller 42 may include a processor 46 and storage 48. The storage may be a non-transitory computer-readable medium having instructions stored thereon that when executed by the processor 46, cause the processor 46 to perform any of the methods described herein. In other embodiments, the controller 42 may be part of an embedded system.

The power supply 44 may be a battery, either a primary battery or a secondary battery (or rechargeable battery). The power supply may also be a power cell. The power supply 44 may provide power to the sensor 40 and the controller 42.

Using the determination based on the monitored acceleration and rotational velocity, a user is alerted that damage is likely to have been caused to the replaceable device 200 and that the replaceable device 200 is, therefore, not suitable for further use. Specifically, the controller 42 is configured to transmit a signal indicating that the replaceable device 200 should be replaced in response to the determination. Advantageously, therefore, use of a personal care appliance 100 whose performance may have been negatively affected by an impact with a surface on which the personal care appliance 100 has been dropped can be avoided, even if this negative impact on performance is not obvious from visual inspection of the personal care appliance 100.

The signal indicating that the replaceable device 200 should be replaced in response to the determination may be an alert signal. The signal may be outputted to a display. For example, the signal may be output to a terminal device (e.g., a smart phone) in (e.g., wireless) communication with the personal care appliance 100. Advantageously, therefore, a user may easily be able to order a replacement replaceable device 200.

In determining that the personal care appliance 100 has experienced an impact rendering the replaceable device 200 unsuitable for further use based on the monitored acceleration and rotational velocity, the controller may be further configured to determine an orientation of the personal care appliance 100 using at least the monitored rotational velocity. Determining the orientation of the personal care appliance 100, advantageously, enables determination of whether the personal care appliance 100 has experienced an impact rendering the replaceable device 200 unsuitable for further use with greater reliability, because the orientation of the personal care appliance 100 on impact is associated with the damage caused to the replaceable device 200 (i.e., the closer the head 120 of the personal care appliance 100 is to the point of impact, the greater the likelihood or damage to the replaceable device 200).

For instance, the controller 42 may be configured to compare the orientation of the personal care appliance 100 to an orientation range at the point of impact and determine that the personal care appliance 100 has experienced an impact rendering the replaceable device 200 unsuitable for further use when the orientation of the personal care appliance 100 is outside the orientation range. In this way, the replaceable device 200 is indicated as requiring replacement when the orientation of the personal care appliance 100 at the point of impact is such that it is at an orientation known to result in damage to the replaceable device 200 with a high degree of likelihood.

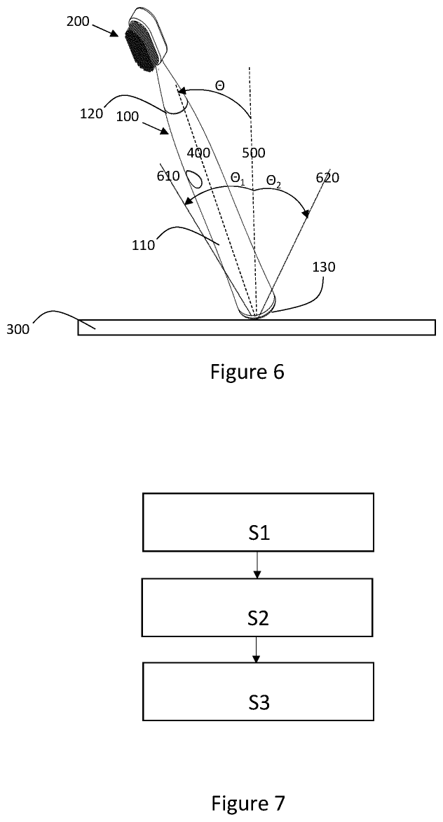

FIG. 6 shows the personal care appliance 100 in the form of a toothbrush as the personal care appliance 100 is about to experience an impact with a surface 300. As shown in FIG. 6, the orientation of the personal care appliance 100 may be measured as an angle ⋅ of a body axis 400 of the handle 110 compared to a substantially vertical axis 500. Advantageously, this measurement of the angle ⋅ captures the aforementioned association between the orientation of the personal care appliance and the likelihood of damage to the replaceable device 200.

As shown in FIG. 6, the orientation range may be between first ⋅₁ and second ⋅₂ angles. The first ⋅₁ and second ⋅₂ angles may be measured from a base 130 of the handle 110 to the head 120 along the body axis 400 of the handle 110, the base 130 of the handle 110 being at an opposite end of the handle 110 from the head 120. In other words, the first ⋅₁ and second ⋅₂ angles may define a cone of safety outside of which the replaceable device 200 is likely to be damaged on impact and require replacement to avoid poor performance of the personal care appliance 100. Put differently, the cone of safety may be defined between the first ⋅₁ and second ⋅₂ angles either side of a vertical axis extending from a point of impact of the base of the handle with a surface. The first ⋅₁ and second ⋅₂ angles may be substantially the magnitude either side of the substantially vertical axis 400. Preferably, the first ⋅₁ and second ⋅₂ angles may be around 20 degrees. Advantageously, it has been found that within this orientation range, damage is not caused to the replaceable device 200.

In determining that the personal care appliance 100 has experienced an impact rendering the replaceable device 200 unsuitable for further use based on the monitored acceleration and rotational velocity, the controller 42 may be further configured to calculate a G-force of the personal care appliance 100 at the point of impact using the sensed acceleration. Determining the G-force of the personal care appliance 100, advantageously, enables determination of whether the personal care appliance 100 has experienced an impact rendering the replaceable device 200 unsuitable for further use with greater reliability, because the G-force of the personal care appliance 100 on impact is associated with the damage caused to the replaceable device 200.

For instance, the controller 42 may be configured to compare the G-force to a G-force threshold and determine that the personal care appliance 100 has experienced the impact rendering the replaceable device 200 unsuitable for further use when the G-force is above the G-force threshold. The G-force threshold may be 2 G-Forces. Advantageously, it has been found that below this G-force threshold, damage is not caused to the replaceable device 200.

FIG. 7 shows a computer-implemented method of determining whether the replaceable device 200 of the personal care appliance 100 is suitable for further use after an impact. The computer-implemented method comprises: monitoring S1 acceleration and rotational velocity, sensed from the sensor in the handle 110 of the personal care appliance 100, over time; determining S2 that the personal care appliance 100 has experienced an impact rendering the replaceable device 200 unsuitable for further use based on the sensed acceleration and rotational velocity; and transmitting S3 the signal indicating that the replaceable device 200 should be replaced in response to the determination that the personal care appliance 100 has experienced an impact rendering the replaceable device 200 unsuitable for further use. The determining S2 may include determining the orientation and/or calculating a G-Force as described above (e.g., in relation to FIG. 6).

In summary, the present disclosure has described a compact personal care appliance 100 that enables users to reliably avoid use of personal care appliances whose performance has been compromised due to an impact and easily replace the relevant part of the personal care appliance 100 damaged by the impact.

Although preferred embodiments have been shown and described, it will be appreciated by those skilled in the art that various changes and modifications might be made without departing from the scope of the invention, as defined in the appended claims and as described above.

All of the features disclosed in this specification (including any accompanying claims and drawings) may be combined in any combination, except combinations where at most some of such features steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

1. A personal care appliance (100) comprising:
a handle (110);
a head (120) at an end of the handle (110), the head (120) having a connection portion (121) connectable to a replaceable device (200);
a sensor (40) configured for sensing acceleration and rotational velocity; and
a controller (42) configured to:
monitor the sensed acceleration and rotational velocity over time;
determine that the personal care appliance (100) has experienced an impact rendering the replaceable device (200) unsuitable for further use based on the monitored acceleration and rotational velocity, by the controller being further configured to:
determine an orientation of the personal care appliance (100) using at least the monitored rotational velocity;
compare the orientation of the personal care appliance (100) to an orientation range at a point of impact;
determine that the personal care appliance (100) has experienced an impact rendering the replaceable device (200) unsuitable for further use when the orientation of the personal care appliance (100) is outside the orientation range; and
transmit a signal indicating that the replaceable device (200) should be replaced in response to the determination that the personal care appliance (100) has experienced an impact rendering the replaceable device (200) unsuitable for further use.

2. The personal care appliance (100) of claim 1, wherein the orientation of the personal care appliance (100) is measured as an angle of a body axis (400) of the handle compared to a substantially vertical axis (500).

3. The personal care appliance (100) of claim 2, wherein the orientation range is between first and second angles, wherein the first and second angles are measured from a base (130) of the handle (110) to the head (120) of the handle (110) along the body axis (400) of the handle (110), the base (130) of the handle (110) being at an opposite end of the handle (110) from the head (120).

4. The personal care appliance (100) of claim 3, wherein the first and second angles are substantially the magnitude either side of the substantially vertical axis (500).

5. The personal care appliance (100) of claim 4, wherein the first and second angles are around 20 degrees.

6. The personal care appliance (100) of claim 1, wherein the controller (42), being configured to determine that the personal care appliance (100) has experienced an impact rendering the replaceable device (200) unsuitable for further use, is further configured to:
calculate a G-force of the personal care appliance (100) at a point of impact using the sensed acceleration;
compare the G-force to a G-force threshold; and
determine that the personal care appliance (100) has experienced the impact rendering the replaceable device (200) unsuitable for further use when the G-force is above the G-force threshold.

7. The personal care appliance (100) of claim 6, wherein the G-force threshold is 2 G-Forces.

8. The personal care appliance (100) of claim 1, wherein the sensor (40) comprises an accelerometer for sensing the acceleration, and/or wherein the sensor (40) comprises a gyroscope for sensing the rotational velocity.

9. The personal care appliance (100) of claim 1, wherein the sensor (40) is located in the handle.

10. The personal care appliance (100) of claim 1, wherein the personal care appliance (100) is a toothbrush or a shaver.

11. The personal care appliance (100) claim 1, further comprises:
the replaceable device (200).

12. A computer-implemented method of determining whether a replaceable device (200) of a personal care appliance (100) is suitable for further use after an impact, the computer-implemented method comprising:
monitoring (S1) acceleration and rotational velocity, sensed from a sensor (40) in a handle (110) of the personal care appliance (100), over time;
determining (S2) that the personal care appliance (100) has experienced an impact rendering the replaceable device (200) unsuitable for further use based on the sensed acceleration and rotational velocity;
determining an orientation of the personal care appliance (100) using at least the monitored rotational velocity;
comparing the orientation of the personal care appliance (100) to an orientation range at a point of impact;
determining that the personal care appliance (100) has experienced an impact rendering the replaceable device (200) unsuitable for further use when the orientation of the personal care appliance (100) is outside the orientation range; and
transmitting (S3) a signal indicating that the replaceable device (200) should be replaced in response to the determination that the personal care appliance (100) has experienced an impact rendering the replaceable device (200) unsuitable for further use.

13. A transitory, or non-transitory, computer readable medium having instructions stored thereon that, when executed by a processor, cause the processor to perform the computer-implemented method of claim 12.
